(19) United States
(12) Patent Application Publication
(10) Pub. No.: US 2009/0064939 A1
(43) Pub. Date: Mar. 12, 2009

(54) Storage Chest Litter Box Holder

(75) Inventors: NOAH ANTHONY CIRINCIONE, Huntington Beach, CA (US); Abigail Ruth Cirincione, Huntington Beach, CA (US)

Correspondence Address: NOAH ANTHONY CIRINCIONE, 8457 BENJAMIN DRIVE, HUNTINGTON BEACH, CA, 92647, US

(73) Assignees: NOAH ANTHONY CIRINCIONE, Huntington Beach, CA (US); ABIGAIL RUTH CIRINCIONE, Huntington Beach, CA (US)

(21) Appl. No.: 12/208,337

(22) Filed: Sep. 11, 2008

Related U.S. Application Data
(60) Provisional application No. 60/971,263, filed on Sep. 11, 2007.

(51) Int. Cl. A01K 29/00

(52) U.S. Cl. 119/161

(57) ABSTRACT

The invention is an enclosure for storing a cat litter pan and/or other pet related articles for a cat or other types of animals. The box has an exterior opening where the cat will enter and also an interior panel with an opening that is staggered with the exterior opening which serves to block litter from getting kicked out on the floor. The two openings also prevent children, dogs, or other animals from getting into the litter box. The two openings are interchangeable so they can be installed on any side of the box. The box opens from the top with a hydraulic safety hinge, allowing it to open and close slowly and also stay open for cleaning. The box has a hook to hang a litter scoop. The box can have different styles, but one style looks like a stylish piece of furniture.

### CROSS-REFERENCE TO RELATED APPLICATIONS

### United States Patents

| | | |
|---|---|---|
| 3,885,523 | 5/1975 | Coleman |
| 4,120,264 | 10/1978 | Carter |
| 6,286,458 | 9/2001 | Rawson |
| 6,376,420 | 4/2002 | Tomlinson |

### RELATED U.S. PATENT & TRADEMARK APPLICATION DATA

This application is a non-provisional utility patent application based on the prior provisional patent application 60/971,263 filed on Sep. 11, 2007.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

This invention relates to the field of animal waste disposal. More specifically, the invention is primarily used as a litter boxes for cats to hold a cat's feces or urine. It can also be used as a receptacle for housing the feces of other household pets.

2. Prior Art

Pets are very popular to have in households. The domestic cat is one of the most popular pets to have. There are approximately 90 million owned cats in the United States and thirty-four percent of U.S. households (or 37.7 million) own at least one cat. Cat owners provide cats with litter boxes to hold the cat's excrement. These litter boxes are typically indoors and are used for domestic cats. These litter boxes maintain a bed of litter or litter material to receive and maintain cat feces and urine.

However, even though cats are great pets and are low-maintenance animals, cat owners will tell you about the problems they face with their litter boxes: the ugly plastic litter pan, the litter tracked throughout the house, the problems trying to hide the box from guests or children, the odors, and the list goes on and on. Cat owners love their cats, but they don't love the cat's litter box. Additionally, some cat owners that also own dogs have noted that sometimes their dogs get into their cat's litter box and this makes a big mess and is not safe for the dog.

Several devices have been invented to try to prevent litter from ending up on the floor of the owner's house and outside of the litter box and these include U.S. Pat. No. 3,885,523 (Coleman), U.S. Pat. No. 4,120,264 (Carter), U.S. Pat. No. 6,286,458 (Rawson), and U.S. Pat. No. 6,376,420 (Tomlinson). All of these devices are structurally different and some have additional features, but one common feature is to prevent litter from being kicked out of the box. However, most of them would not prevent a child or a medium or large sized dog or another animal from getting inside the litter box. Also some litter will still come out onto the floor based on those designs.

The present invention is a Storage Chest Litter Box Holder and is sold under the name of Designer Catbox™ at www.DesignerCatbox.com and helps to solve the problems facing cat owners. The invention has been sold since March 2008. The invention looks like an elegant chest. It also includes a staggered interior panel that keeps the cat from kicking litter out of the box and also prevents children or dogs from getting inside the box. The features of this invention cooperate in a very meaningful and a non-obvious way and result in a superior litter box over existing prior art.

### BRIEF SUMMARY OF THE INVENTION

The present invention pertains to a litter box and represents an improvement over prior art in that it prevents litter from getting kicked out of the litter box but also prevents a child or a medium or large sized dog or another animal from getting inside the litter box. The invention is a litter box for storing a cat litter pan and other cat and/or pet related articles for cats or other types of animals. The litter box has an exterior hole where the cat will enter. The box also has an interior panel with a hole that is strategically placed which serves to block litter from getting kicked out on the floor. The two holes are interchangeable so they can be installed on any side of the box. The box opens from the top with a hydraulic safety hinge, allowing it to open and close slowly and also stay open for cleaning. This top opening allows for easy access to the inside of the box, making cleaning the litter pan and getting other pet articles easy. The box has a hook to hang a litter scoop. There is space in the box for storage of a litter pan as well as other products for a cat such as litter deodorizer and other cat items. The box can have different styles, but one style looks like a stylish piece of furniture. Also, the box could be used for different types of animals besides cats.

### BRIEF DESCRIPTION OF THE SEVERAL VIEWS OF THE DRAWING

The invention is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Included in the drawing are the following figures. In the accompanying drawings, the preferred embodiment of the invention and preferred methods of practicing the invention are illustrated in which:

FIG. 1 is a right perspective view of the storage chest litter box holder with the exterior hole installed on the right side thereof;

FIG. 2 is a left perspective view of the storage chest litter box holder with the exterior hole installed on the right side thereof;

FIG. 3 is a left perspective view of the storage chest litter box holder with the exterior hole installed on the left side thereof;

FIG. 4 is a right perspective view of the storage chest litter box holder with the exterior hole installed on the left side thereof;

FIG. 5 is a front elevational view thereof;

FIG. 6 is a left side elevational view of the storage chest litter box holder with the exterior hole installed on the right side thereof;

FIG. 7 is a right side elevational view of the storage chest litter box holder with the exterior hole installed on the right side thereof;

FIG. 8 is a back elevational view thereof;

FIG. 9 is a bottom plan view thereof;

FIG. 10 is left side elevational view of the storage chest litter box holder with the top open. The holes are installed on the left side. The interior panel can be seen with the hole thereof;

FIG. 11 is a right side elevational view of the storage chest litter box holder with the top open. The holes are installed on the right side. The interior panel can be seen with the hole thereof.

FIG. 12 is a top plan view of the storage chest litter box with the top open. The holes are installed on the left side and a litter pan holding litter is placed in the larger chamber of the box.

### DETAILED DESCRIPTION OF THE INVENTION

As shown in the Figures, the present invention is a litter box for storing a cat litter pan and other cat and/or pet related articles for cats or other types of animals. The invention hides the litter pan in an elegant piece of furniture. This product is designed to assist cat owners in maintaining a stylish and elegant home without sacrificing care and comfort for their pets. The invention is a revolutionary new product for cat owners.

The present invention is a box made up of a front panel 3, a back panel 9, a bottom panel 7, and a lid 4. There are two side panels that are interchangeable: a side panel with the exterior hole 1, and a side panel without an exterior hole 6. These can be set up on either side of the litter box, depending on preference, so that the side panel with the exterior hole 1 can be hidden from view when placed in a room.

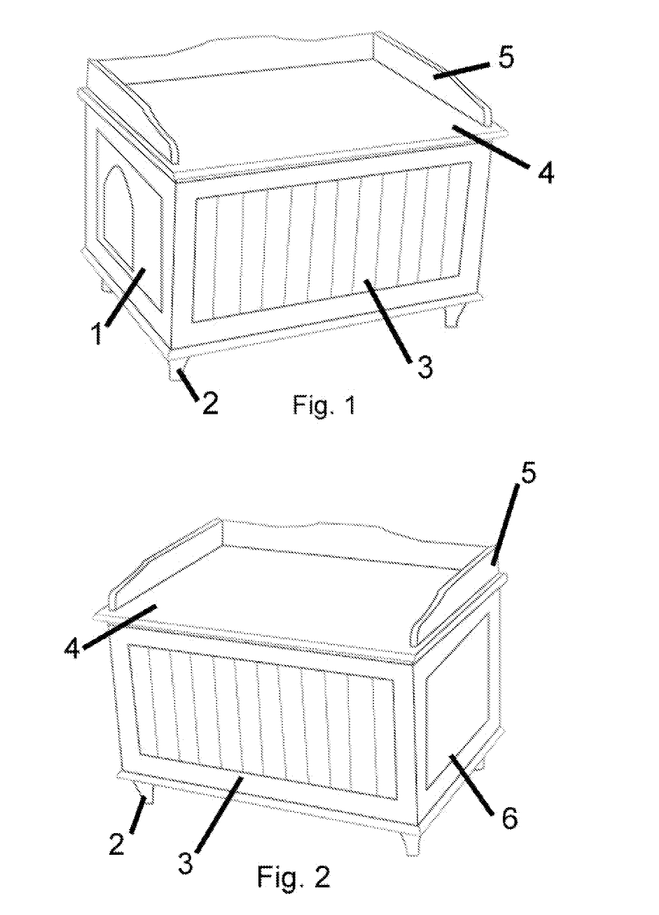

FIG. 1 is a right side perspective view that demonstrates the invention with the side panel with an exterior hole 1 set up on the right side. The lid 4 is closed, thus concealing the litter pan. Elegant wainscoting on the front panel 3 and decorative edging 5 help the litter box to look like a piece of furniture. The feet 2 on the litter box lift it off the floor and add to the visual appeal. FIG. 2 is a left side perspective view of the litter box with the side panel with the exterior hole 1 set up on the right side. From this view, the side panel without an exterior hole 6 is showing, and the side panel with an exterior hole 1 is hidden from view, thus making the invention look like a piece of furniture and hiding the cat's litter pan.

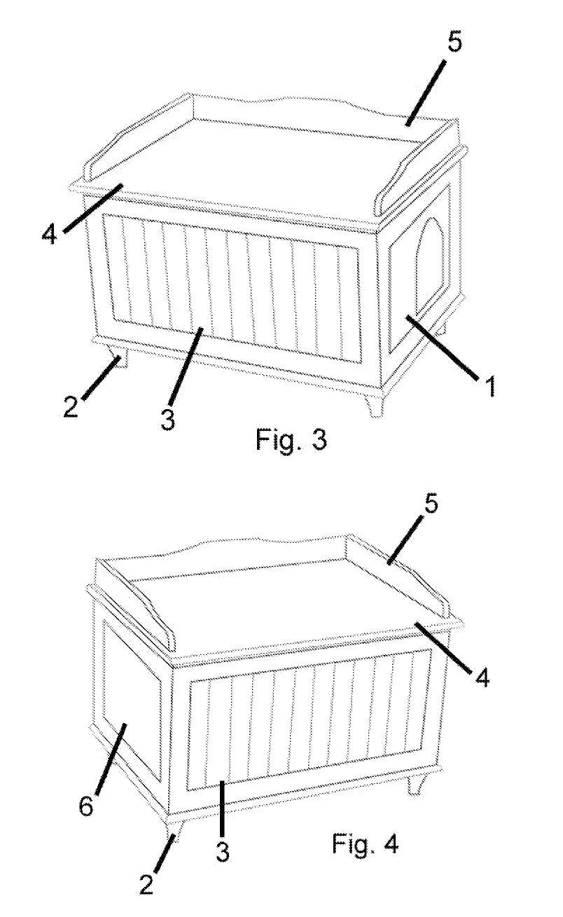

FIG. 3 is a left side perspective view that demonstrates the invention with the side panel with the exterior hole 1 set up on the left side. FIG. 4 is a right perspective view of the litter box with the side panel without an exterior hole 6 showing.

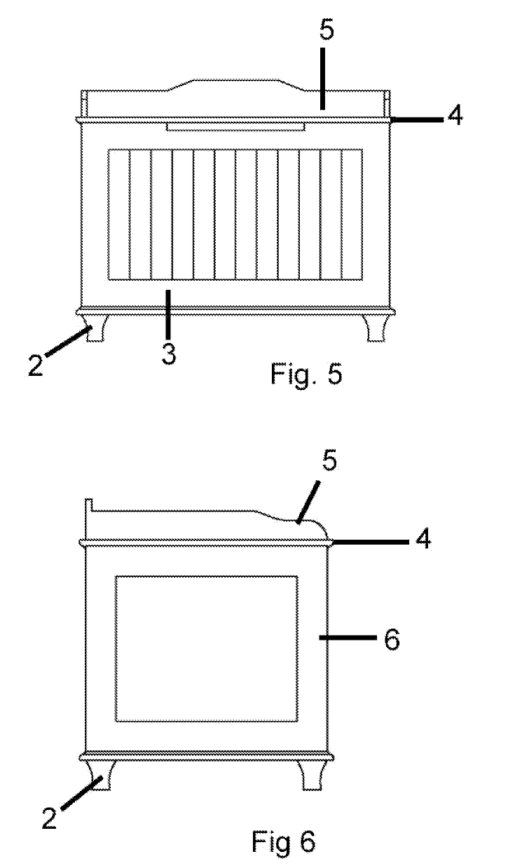

From the front, the litter box looks like a piece of furniture. FIG. 5 shows that from the front elevational view, the side panel with the exterior hole 1 is hidden, and the front panel 3 with the wainscoting and the edging 5 can be seen. With the lid 4 closed, the invention looks like a storage chest.

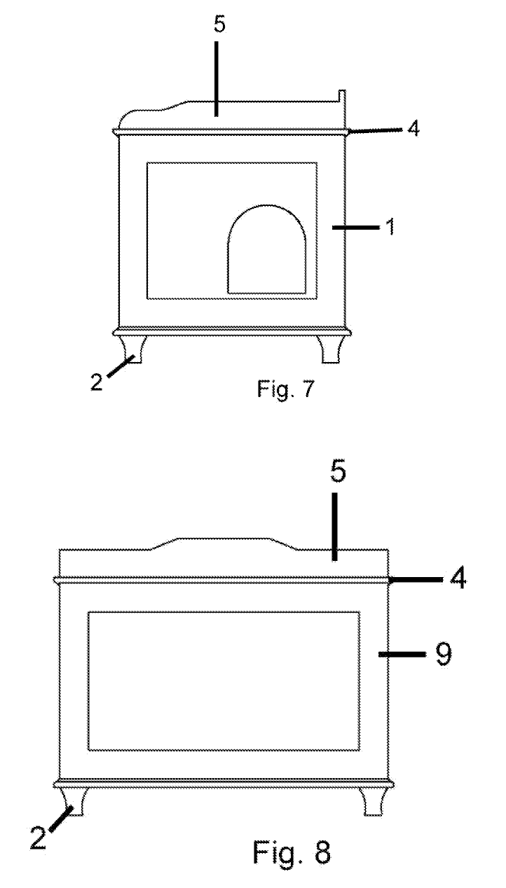

FIG. 6 and FIG. 7 are elevational views of the side panel with no exterior hole 6 and the side panel with the exterior hole 1, respectively. In this setup, the side panel with no exterior hole 6 is set up on the left side of the litter box. The back panel 7 of the litter box is flat, as demonstrated in FIG. 8, so that it will fit easily along a wall.

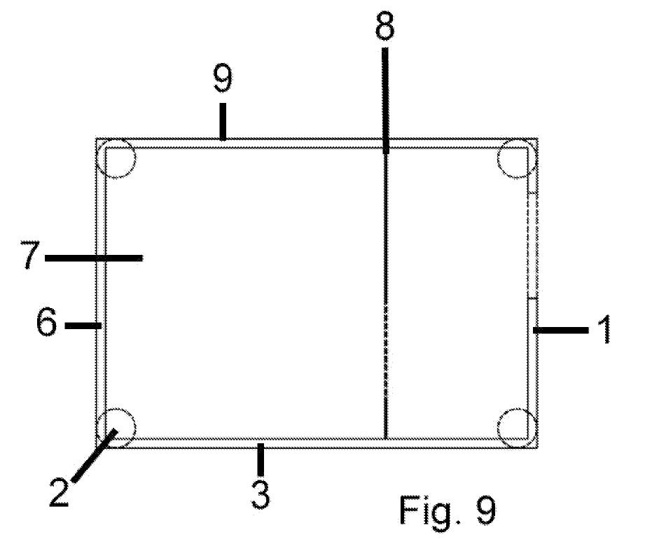

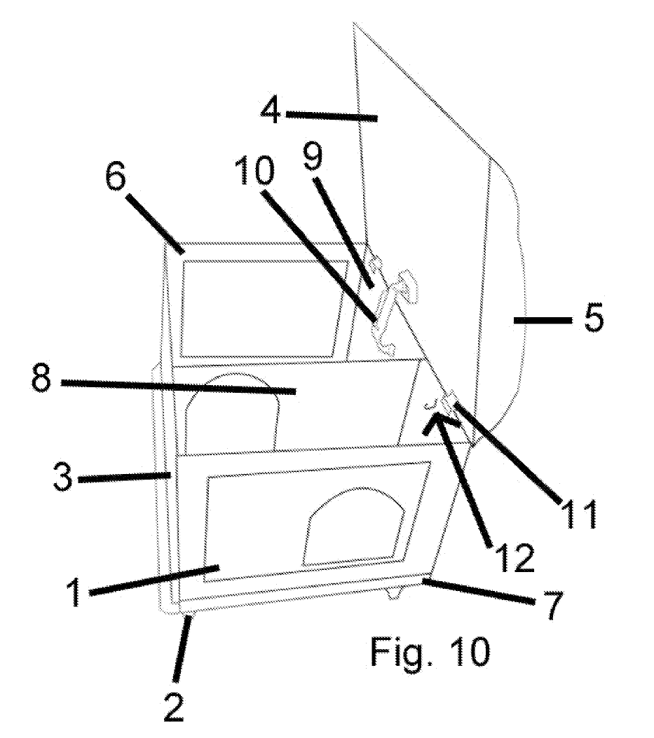

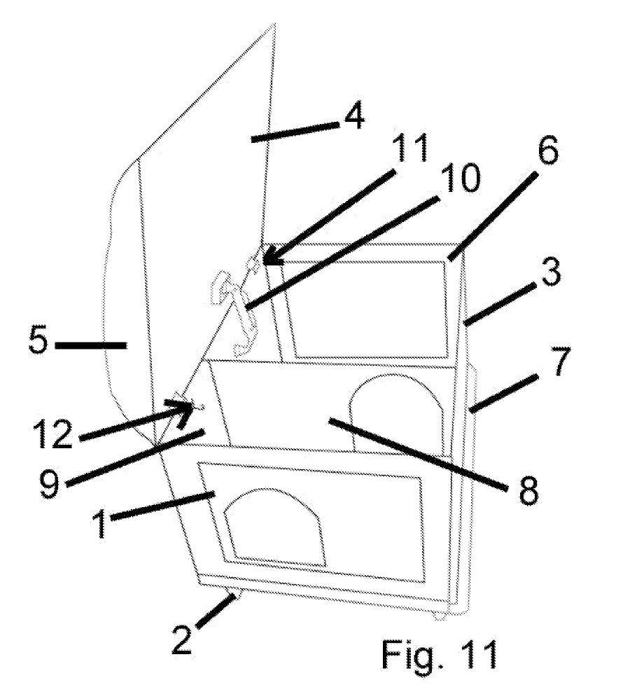

The interior panel 8 has a hole that is installed on the side of the box that has the side panel with the exterior hole 1, as demonstrated in FIG. 9. FIG. 10 demonstrates a litter box with lid 4 open and the side panel with the exterior hole 1 set up on the left side of the box. The interior panel 8 is also installed on the left side of the box and the hole in the interior panel 8 is staggered from hole in the side panel with the exterior hole 1. FIG. 11 demonstrates a litter box with lid 4 open and the side panel with the exterior hole 1 set up on the right side of the box. The interior panel 8 is also installed on the left side of the box and the hole in the interior panel 8 is staggered from hole in the side panel with the exterior hole 1. The lid 4 is attached to the back panel 9 using two hinges 11. The hydraulic safety hinge 10 allows the lid 4 to stay in the opened position and also helps to close the lid 4 slowly to keep a customer's fingers safe. The ability to leave the lid 4 open allows for easy access to the inside of the box, making cleaning the litter pan and getting other pet articles easy. Inside the box there is a storage area for the litter pan. In FIG. 10 the litter pan storage area is in the far end of the box, just past the interior panel 8. Additionally there is a separate storage area for the litter scoop and there is a litter scoop hook 12 designed to hold the cat litter scoop. There is additional room in this compartment to store litter deodorizer and other cat or pet accessories so that they are completely hidden from family and guests.

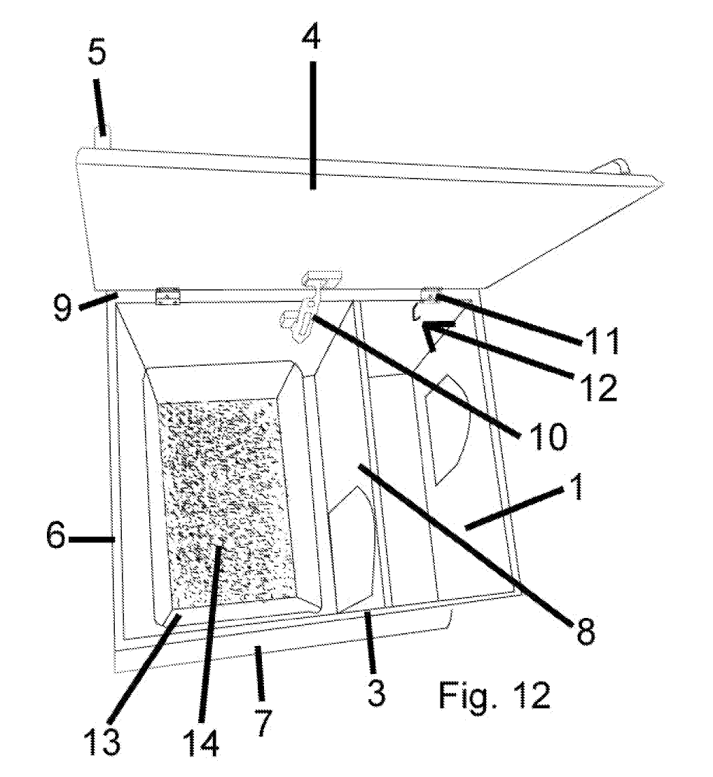

FIG. 12 is a top plan view of the litter box in use, with the lid 4 open and a litter pan 13 and litter 14 in the litter pan 13. The cat will first enter through the side panel with the exterior hole 1 then the cat will go through the second hole in the interior panel 8. The interior panel 8 is designed to block litter that the cat kicks out when it is using the litter pan so the litter is not kicked to the floor. The hole on the interior panel 8 can be setup toward the front of the box while the side panel with the exterior hole 1 outside of the box can be setup toward the back of the box so it is more hidden. The two holes that the cat must go through are strategically placed and not overlapping so that if the cat kicks litter through the interior panel hole it will hit the inside of the box instead of going out of the box and onto the floor. This feature allows the box to be left untouched for a number of days and the area around the box will still be kept clean where with other litter boxes there would be litter all over the floor.

The process for making the Storage Chest Litter Box Holder is as follows. The panels can be made of wood or another material. Cut a hole in the side panel so that it has an exterior hole 1 big enough for a cat to enter. Cut a hole in the interior panel 8 big enough for a cat to enter. Then the box can be assembled. Attach the side panel with the exterior hole 1 to one side of the bottom panel 7, and attach the side panel without an exterior hole 6 to the opposite side. Next the front panel 3 should be attached to the bottom panel 7 and then to the side panel with the exterior hole 1 and then to the side panel without an exterior hole 6. After this, the interior panel 8 should be installed and attached to the front panel 3. Then the back panel 9 should be installed and attached to the bottom panel 7 then the side panel with the exterior hole 1 and then to the side panel without an exterior hole 6 and then the interior panel 8. After this, attach the lid 4 to the back panel 9 using the hinges 11 and hydraulic safety hinge 10. Attach the edging 5 to the top of the lid 4. Attach the litter scoop hook 12 into the wall on the back panel 9. Finally install the four feet 2 onto the bottom of the bottom panel 7. The setup is now complete.

The preceding merely illustrates the principles of the invention. It will thus be appreciated that those skilled in the art will be able to devise various arrangements which, although not explicitly described or shown herein, embody the principals of the invention and are included within its spirit and scope. Furthermore, all examples and conditional language recited herein are principally intended expressly to be only for pedagogical purposes and to aid the reader in understanding the principals of the invention and the concepts contributed by the inventors to furthering the art, and are to be construed as being without limitation to such specifically recited examples and conditions. Moreover, all statements herein reciting principals, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This detailed description of the invention is intended to be read in connection with the figures of the accompanying drawing, which are to be considered part of the entire written description.

Although the invention has been described in terms of exemplary embodiments, it is not limited thereto. Rather, the appended claims and specification should be construed broadly, to include other variants and embodiments of the invention, which may be made by those skilled in the art without departing from the scope and range of equivalents of the invention.

What is claimed is:

1. An enclosure for storing a litter pan and/or other pet related articles for a cat or other species of animals which comprises of an exterior opening on an exterior panel of the enclosure and an interior opening on an interior panel of the enclosure.

2. An enclosure as in claim 1, wherein the exterior opening on the side of the enclosure where the cat will enter with an opening large enough to allow the cat to pass though.

3. An enclosure as in claim 1, wherein the exterior opening can be setup by a customer to be on any side of the enclosure, according to the customer's choosing.

4. An enclosure as in claim 1, wherein the exterior opening could be easily installed by a user on the right or the left sides of the enclosure, whichever is the more convenient position for the user.

5. An enclosure as in claim 1, wherein one or more interior panels divide the enclosure into distinct chambers allowing storage in each chamber.

6. An enclosure as in claim 1, wherein the openings on the interior panel and exterior panel are staggered.

7. An enclosure as in claim 1, wherein the interior panel with opening and exterior panel with opening are strategically placed to block litter from getting kicked out on the floor.

8. An enclosure as in claim 1, wherein the enclosure panels with openings are installed such that the exterior opening would be toward the back of the enclosure and the interior opening would be toward the front of the enclosure so that if the cat kicks litter through the interior panel opening it will hit the inside panel and outside panel instead of going out of the exterior opening in the enclosure and onto the floor. An alternative arrangement would be if the enclosure panels with openings were installed such that the exterior opening would be toward the front of the enclosure and the interior opening would be toward the back of the enclosure.

9. An enclosure as in claim 1, with a bottom piece, front wall, a back wall, a left wall, a right wall, and a top piece.

10. An enclosure as in claim 1, with a top piece that enables a user to open the top piece.

11. An enclosure as in claim 1, with a top piece where the top piece opens up from fasteners that connect the back wall and the top piece. These fasteners allow the top piece to open up to allow access to the contents of the enclosure.

12. An enclosure as in claim 1, with a top piece where the top piece opens up from fasteners that connect the back wall and the top piece. These fasteners allow the top piece to open up to allow access to the contents of the enclosure and a hydraulic safety hinge is connected between the back wall and the top piece. This hydraulic safety hinge allows the top piece to open and close slowly and also to stay open for the user for cleaning or accessing the enclosure's contents.

13. An enclosure as in claim 1, with a hook to hang a litter scoop.

14. An enclosure as in claim 1, where the enclosure could be made from a number of different materials including but not limited to: wood, medium-density fiberboard, plastic, melamine, wood products, plastic products, engineered wood, glued laminated timber, plywood, parallam, parallel strand lumber, particle board, wafer board, fiberboard, hamasote, masonite, hardboard, cement board, gypsum board, papercrete, strawboard, or others.

15. An enclosure as described in claim 1, to be used for several species of animals including but not limited to: cats, dogs, rabbits, guinea pigs, gerbils, hamsters, mice, rats, or others.

16. An enclosure for storing a litter pan and/or other pet related articles for a cat or other species of animals which looks like a stylish piece of furniture.

17. An enclosure as in claim 16 consisting of an exterior opening on an exterior panel of the enclosure and an interior opening on an interior panel of the enclosure.

18. An enclosure as in claim 16 consisting of an interior panel with opening and exterior panel with opening wherein the openings on the interior panel and exterior panel are staggered.

19. An enclosure as in claim 16 consisting of an interior panel with opening and exterior panel with opening that are strategically placed to block litter from getting kicked out on the floor.

20. An enclosure as in claim 16 consisting of one or more interior panels that divide the enclosure into distinct chambers allowing storage in each chamber.
